(19) United States
(12) Patent Application Publication
(10) Pub. No.: US 2010/0174530 A1
(43) Pub. Date: Jul. 8, 2010

(54) ELECTRONIC AUDIO PLAYING APPARATUS WITH AN INTERACTIVE FUNCTION AND METHOD THEREOF

(75) Inventors: HSIAO-CHUNG CHOU, Tu-Cheng (TW); LI-ZHANG HUANG, Tu-Cheng (TW); CHUAN-HONG WANG, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/434,675

(22) Filed: May 3, 2009

(30) Foreign Application Priority Data
Jan. 5, 2009 (CN) 200910300036.0

(51) Int. Cl. G10L 19/00

(52) U.S. Cl. 704/201

(57) ABSTRACT

An audio playing apparatus with an interactive function is provided. An interactive file stored in a data storage of the audio playing apparatus includes controlling data, a main audio, and at least one question audio. The controlling data is for controlling the playing controlling data of the main audio and the question audios. After each question audio is played, the audio playing apparatus output a voice prompt to give user a reference answer.

### BACKGROUND

1. Technical Field

The present disclosure relates to an audio playing apparatus with an interactive function and a method thereof.

2. Description of Related Art

Current audio file formats commonly used are, among others, AAC, AC-3, ATRAC3plus, MP3, and WMA9. Users can only play such files and cannot interact with them.

Therefore, what is needed is an audio playing apparatus with interactive function for audio files and a method for such an apparatus to achieve the function.

### BRIEF DESCRIPTION OF THE DRAWINGS

The components of the drawings are not necessarily drawn to scale, the emphasis instead being placed upon clearly illustrating the principles of the electronic audio playing apparatus. Moreover, in the drawings, like reference numerals designate corresponding parts throughout several views.

FIG. 1 is a block diagram of an audio playing apparatus with an interactive function in accordance with a first exemplary embodiment.

FIG. 2 is a schematic diagram of a first exemplary data structure of interactive file stored in the audio playing apparatus of FIG. 1.

FIG. 3 is a schematic diagram of a second exemplary data structure of the interactive file.

FIG. 4 is a schematic diagram of an audio question file access method in accordance with an exemplary embodiment.

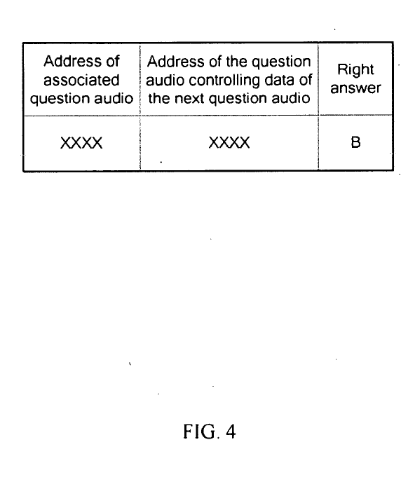

FIG. 5 is a schematic diagram of a voice prompt database schema in accordance with an exemplary embodiment.

FIG. 6 is a flowchart of an interactive method applied on the audio playing apparatus of FIG. 1, in accordance with an exemplary embodiment.

FIG. 7 is a block diagram of an audio playing apparatus with an interactive function in accordance with a second exemplary embodiment.

FIG. 8 is a flowchart of an interactive method applied on the audio playing apparatus of FIG. 7, in accordance with an exemplary embodiment.

### DETAILED DESCRIPTION

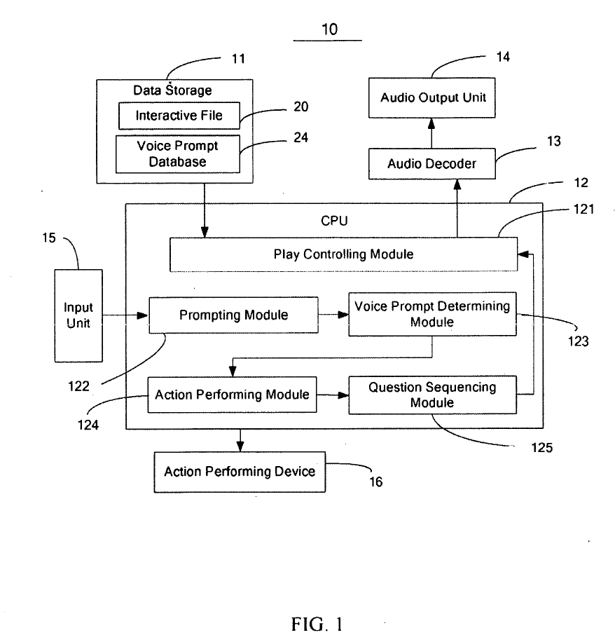

FIG. 1 is a block diagram of an electronic audio playing apparatus with an interactive function (hereafter “the apparatus”) in accordance with a first exemplary embodiment. The apparatus 10 can interact with users. For example, when the apparatus 10 is configured for use in an educational environment it can automatically play audio files that are questions for the user to answer after the user has listened to some study material. Additionally, there are audio files that can be played during the time the device awaits an answer from the user, that can be used, for example, to motivate or heckle the user. When the apparatus 10 finishes outputting an audio file, the apparatus 10 generates and outputs a question to users.

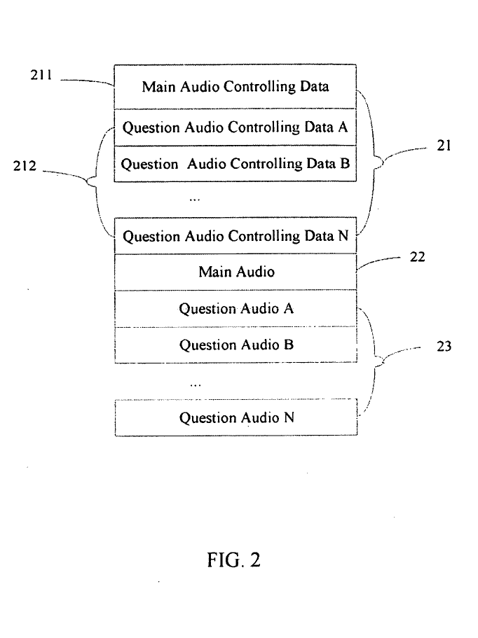

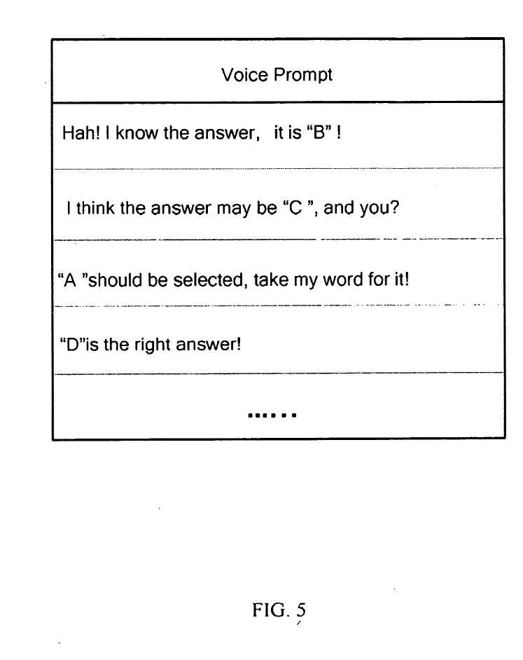

The apparatus 10 includes a data storage 11, a central processing unit (CPU) 12, an audio decoder 13, an audio output unit 14, an input unit 15, and an action performing device 16. The data storage 11 stores at least one interactive file 20, and a voice prompt database 24. Referring to FIG. 2, each interactive file 20 includes controlling data 21, a main audio 22, and at least one question audio 23. Content of the main audio 22 is, for example, a story, a song, an article or other audio content. The at least one question audio 23 is a question regarding content of the main audio 22. The voice prompt database 24 (as shown in FIG. 5) includes at least one voice prompt. The voice prompt is configured for giving the user a reference answer for the question audio 23. The reference answer may be used as an obstacle to confuse the user and thus to detect whether the user really understands the content of the main audio 22.

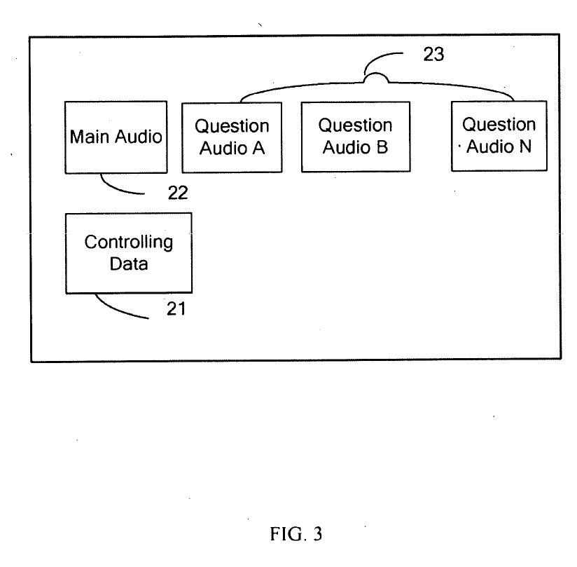

In another embodiment, the controlling data 21, the main audio 22, and each of the question audios 23 are stored in the data storage 11 as separate files, as shown in FIG. 3.

The controlling data 21 is a kind of metadata that describes the structure of the interactive file 20. The controlling data includes a main audio controlling data 211 and a plurality of question audio controlling data 212. The main audio controlling data 211 includes address of the main audio 21.

Each of the question audio controlling data 212 is associated with a question audio 23, and includes information related to the associated question audio 23. For example, the question audio controlling data 212 records address of the associated question audio 23, the address of the question audio controlling data 212 of the next question audio 23, and a right answer of the associated question audio 23.

The CPU 12 includes a play controlling module 121, a prompting module 122, a voice prompt determining module 123, an action performing module 124, and a question sequencing module 125.

The play controlling module 121 is for accessing the controlling data 21 of the interactive file 20, and further accessing the main audio 22 according to the address included in the main audio controlling data 211, and accessing the question audios 23 according to the addresses recorded in the question audio controlling data 212. After decoding by the decoder 13, the accessed main audio 22 and question audio 23 is output by the audio output unit 14.

The prompting module 122 is for randomly selecting a voice prompt from the voice prompt database 24 after each question audio 23 is played and outputting the voice prompt through the audio output unit 14 after decoded.

The voice prompt determining module 123 is for comparing the reference answer in the voice prompt with the right answer recorded in the question audio controlling data 212 to determine whether the voice prompt is a right prompt or a wrong prompt to determine what kind of action will be performed as described in the following paragraph.

The action performing module 124 is for controlling the action performing device 16 to perform an action corresponding to the comparison result. Taking a toy or robot for example, if the comparison result is a right prompt, the action performing module 124 controls the action performing device 16, e.g., the head of the toy, to nod; if the comparison result is the wrong prompt, the action performing module 124 controls the head of the toy to shake.

The question sequencing module 125 is for determining whether the address of the question audio controlling data 212 of the next question audio 23 is predetermined value. The predetermined value is for expressing that the associated question audio currently played of the question audio controlling data 212 is the last question audio. If the address of the question audio controlling data 212 of the next question audio 23 is a predetermined value, the question sequencing module 125 ends playing the interactive file 20. If the address of the next question audio controlling data 212 is not a predetermined value, namely, the associated question audio currently played of the question audio controlling data 212 is not the last question audio, the question sequencing module 125 notifies the play controlling module 121 to access the next question audio controlling data 212 according to the corresponding address.

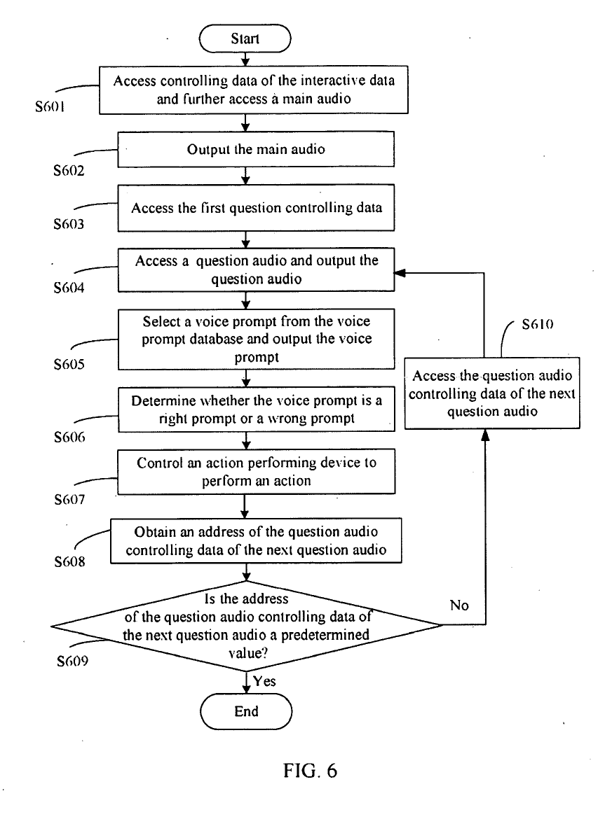

FIG. 6 is a flowchart of an interactive method applied on the audio playing apparatus of FIG. 1. In step S601, the play controlling module 121 accesses the controlling data 21 of the interactive file 20, and further accesses the main audio 22 according to the address of the main audio 22 recorded in the main audio controlling data 211.

In step S602, after decoded by the decoder 13, the accessed main audio 22 is output through the audio output unit 14.

In step S603, the play controlling module 121 accesses the first question audio controlling data 212 from the controlling data 21.

In step S604, the play controlling module 121 accesses the question audio 23 according to the address included in the accessed question audio controlling data 212, and outputs the accessed question audio 23 through the audio output unit 14 after the accessed question audio 23 is decoded by the decoder 13.

In step S605, the prompting module 122 randomly selects a voice prompt from the voice prompt database 24 and outputs the voice prompt through the audio output unit 14 after the voice prompt is decoded.

In step S606, the voice prompt determining module 124 compares the reference answer in the voice prompt with the right answer recorded in the question audio controlling data 212 to determine whether the voice prompt is the right prompt or the wrong prompt.

In step S607, the action performing module 124 controls the action performing device 16 to perform an action corresponding to the comparison result.

In step S608, the question sequencing module 125 obtains the address of the question audio controlling data 212 of the next question audio 23.

In step S609, the question sequencing module 125 determines whether the address of the next question audio controlling data 212 is a predetermined value. If the address of the next question audio controlling data 212 is a predetermined value, the question sequencing module 125 ends playing the interactive file 20.

If the address of the next question audio controlling data is not a predetermined value, in step S610, the question sequencing module 125 notifies the play controlling module 121 to access the next question audio controlling data 212 according to the address of the next question audio controlling data 212, and the procedure goes to step S604.

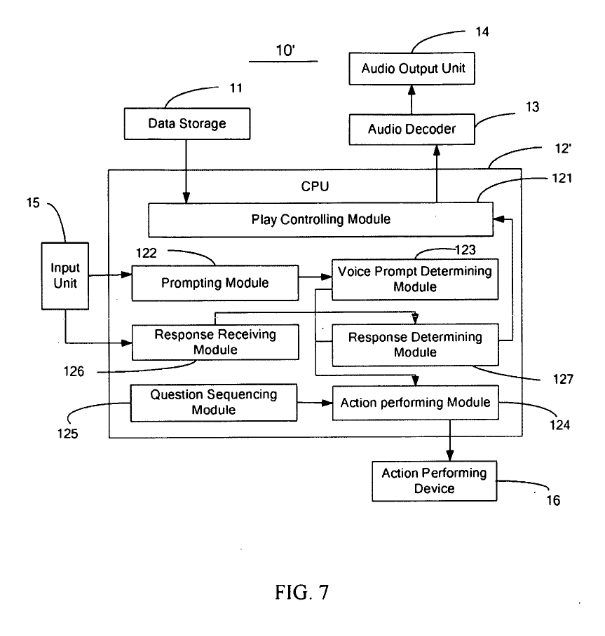

FIG. 7 is another structure diagram of the electronic audio playing apparatus in accordance with the second exemplary embodiment. In the second exemplary embodiment, the CPU 12′ of the apparatus 10′ further includes a response receiving module 126 and a response determining module 127. The response receiving module 126 is for receiving and recognizing input signals generated by the input unit 15 and thus to determine response answers from the user. The input unit 15 can be buttons, touch sensors, or an audio input device such as a microphone. In this exemplary embodiment, the input unit 15 is buttons. Accordingly, the user can input different response answers by pressing different buttons. For example, there can be four buttons A-D for inputting answers A-D.

The response determining module 127 is for comparing the response answer from the user with the right answer included in the question audio controlling data 212 to determine whether the response answer from user is a right or wrong answer.

The action performing module 124 generates a composite result according to the determined result from the voice prompt determining module 123 and the determined result from the response determining module 127. The composite result may be one of the following four types. The first type is that the voice prompt is the right prompt and the response answer from user is the right answer. The second type is that the voice prompt is the right prompt and the response answer from the user is the wrong answer. The third type is that the voice prompt is the wrong prompt and the response answer from user is the right answer. The fourth type is that the voice prompt is the wrong prompt and the response answer from the user is the wrong answer. The action performing module 124 controls the action performing device 16 to perform action to express the type of the composite result. Taking a toy as the apparatus 10/10′ for example, if the composite result is the first type, the action performing module 124 controls the action performing device 16, e.g., the head of the toy, to nod; if the composite result is the second type, the action performing module 124 controls the head of the toy to shake; if the composite result is the third type, the action performing module 124 controls another action performing device 16, e.g., the nose of the toy, to elongate; and if the composite result is the fourth type, the action performing module 124 controls another action performing device 16, e.g., the eye of the toy, to wink.

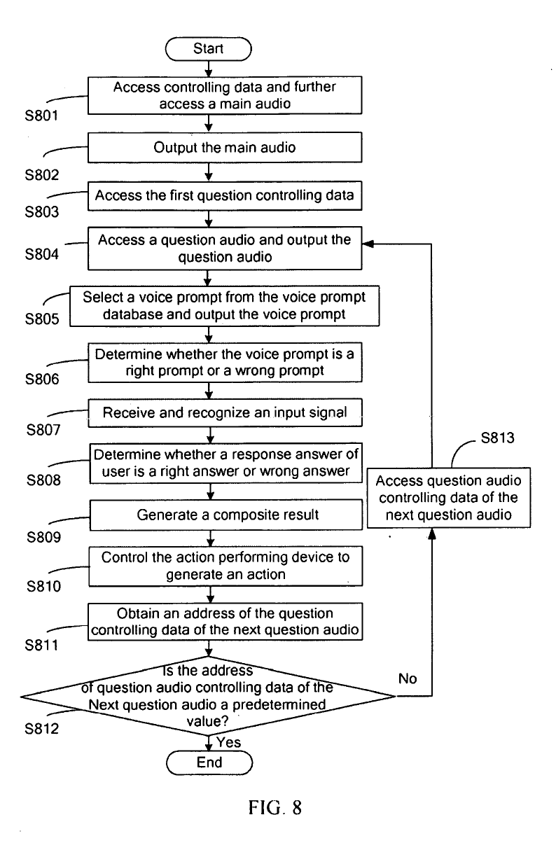

FIG. 8 is a flowchart of an interactive method applied on the audio playing apparatus 10′ of FIG. 7. Steps S801-S806 of this interactive method is the same as steps S601-S606 of the interactive method described above, accordingly, the description of steps S801-S806 are omitted herein.

In step S807, the response receiving module 126 receives and recognizes the input signals generated by the input unit 15 to determine the response answer from the user.

In step S808, the response determining module 127 compares the received response answer from the user with the right answer includes in the question audio controlling data 212 to determine whether the response answer from user is a right answer or a wrong answer.

In step S809, the action performing module 124 generates the composite result according to the determining result of the voice prompt determining Module 123 and the determining result of the response determining module 127.

In step S810, the action performing module 124 controls the action performing device 16 to perform an action according to the type of the composite result.

In step S811, the question sequencing module 125 obtains the address of the next question audio controlling data 212 from the question audio controlling data 212.

In step S812, the question sequencing module 125 determines whether the address of the next question audio controlling data 212 is a predetermined value. If the address of the next question audio controlling data 212 is a predetermined value, the question sequencing module 125 ends playing the interactive file 20.

If the address of the next question audio controlling data is not a predetermined value, in step S813, the question sequencing module 125 notices the play controlling module 121 to access the next question audio controlling data 212 according to the address of the next question audio controlling data 212, and the procedure goes to S804.

Although the present invention has been specifically described on the basis of preferred embodiments, the invention is not to be construed as being limited thereto. Various changes or modifications may be made to the embodiment without departing from the scope and spirit of the invention.

What is claimed is:

1. An audio playing apparatus with an interactive function, comprising:
a data storage for storing at least one interactive file and a voice prompt database, wherein the interactive file comprises controlling data, a main audio, and at least one question audio, the controlling data includes a main audio controlling data and a plurality of question audio controlling data each of which is associated with one question audio, the question audio controlling data comprises address of associate question audio and address of question audio controlling data of the next question audio, the voice prompt database comprises at least a piece of voice prompt;
a play controlling module for accessing the controlling data of the interactive file, and further accessing the main audio according to the address of the main audio comprised in the main audio controlling data, and accessing the question audio according to the address of the question audio comprised in the question audio controlling data, outputting the accessed main audio and question audio through an audio output unit;
a prompting module for randomly selecting a voice prompt from the voice prompt database after each question audio is played and outputting the voice prompt through the audio output unit;
a question sequencing module for accessing the address of question audio controlling data of the next question audio from the question audio controlling data of the question audio currently played, and notify the play controlling module to access the next question audio according to the address of the question audio controlling data of the next question audio.

2. The apparatus as described in claim 1, wherein the question audio controlling data further comprises a right answer of the associated question audio, the voice prompt gives user a reference answer for the question audio, the apparatus further comprises a voice prompt determining module and an action performing module, the voice prompt determining module is for comparing the reference answer and the right answer to determine whether the voice prompt is a right prompt or a wrong prompt, the action performing module is for controlling an action performing device to perform an action according to the comparison result.

3. The apparatus as described in claim 2, wherein the apparatus further comprises a response receiving module and a response determining module, the response receiving module is for receiving and recognizing input signals generated by an input unit and determines response answers from the user, the response determining module is for comparing the received response answer of the user with the right answer comprised in the question audio controlling data to determine whether the response answer is a right answer or wrong answer; the action performing module generates a composite result according to the determined result of the voice prompt determining module and the determined result of the response determining module, and controls the action performing device to perform an action according to the composite result.

4. The apparatus as described in claim 3, wherein the composite result has four types, the first type is that the voice prompt is the right prompt and the response answer of user is the right answer, the second type is that the voice prompt is the right prompt and the response answer of user is the wrong answer, the third type is that the voice prompt is the wrong prompt and the response answer of user is the right answer, the fourth type is that the voice prompt is the wrong prompt and the response answer of user is the wrong answer.

5. The apparatus as described in claim 1, wherein the controlling data, the main audio, and a plurality of question audios are stored in the data storage as separate files, which are the at least one interactive file.

6. An interactive method applied on an audio playing apparatus, comprising:
(a) providing a data storage for storing at least one interactive file and a voice prompt database, wherein the interactive file comprises controlling data, a main audio, and at least one question audio, the controlling data includes a main audio controlling data and a plurality of question audio controlling data each of which is associated with one question audio, the question audio controlling data comprises address of associate question audio and address of question audio controlling data of the next question audio, the voice prompt database comprises at least a piece of voice prompt;
(b) accessing controlling data of the interactive file;
(c) accessing the main audio according to the address of the main audio which comprised in the main audio controlling data and outputting the accessed main audio through an audio output unit;
(d) accessing the first question audio controlling data from the controlling data;
(e) accessing the question audio according to the address of the question audio which comprised in the question audio controlling data and outputting the accessed question audio through the audio output unit;
(f) selecting a voice prompt from the voice prompt database after the question audio is played and outputting the voice prompt through the audio output unit; and
(g) accessing the address of question audio controlling data of the next question audio from the question audio controlling data of the question audio currently played, then goes to step (d).

7. The interactive method as described in claim 6, wherein the question audio controlling data further comprise a right answer of the associate question audio, the voice prompt gives user a reference answer for the question audio, the interactive method further comprises:
(h) comparing the reference answer and the right answer to determine whether the voice prompt is a right prompt or a wrong prompt; and
(i) controlling an action performing device to perform an action according to the comparison result.

8. The interactive method as described in claim 7, further comprising:
(j) receiving and recognizing input signals generated by an input unit and determining response answers from the user;
(k) comparing the received response answer of the user with the right answer comprised in the question audio controlling data to determine whether the response answer is a right answer or wrong answer;
(l) generating a composite result according to the determining result of step (h) and step (k); and
(m) controlling the action performing device to perform an action according to the composite result.

9. The interactive method as described in claim 8, wherein the composite result has four types, the first type is that the voice prompt is the right prompt and the response of user is the right response, the second type is that the voice prompt is the right prompt and the response of user is the wrong response, the third type is that the voice prompt is the wrong prompt and the response of user is the right response, the fourth type is that the voice prompt is the wrong prompt and the response of user is the wrong response.

10. The interactive method as described in claim 6, wherein the controlling data, the main audio, and a plurality of question audios are stored in the data storage as separate files, which are the at least one interactive file.
